(19) United States
(12) Patent Application Publication
(10) Pub. No.: US 2026/0323626 A1
(43) Pub. Date: Oct. 15, 2026

(54) RECEPTION OF SCHEDULING REQUESTS USING A NARROWBAND RECEIVER

(71) Applicant: Telefonaktiebolaget LM Ericsson (publ), Stockholm (SE)

(72) Inventors: Magnus HURD, Stockholm (SE); Anteneh Atumo GEBREMARIAM, Lund (SE); Hong ZHU, Lund (SE); Zhiming YIN, Danderyd (SE)

(21) Appl. No.: 19/475,607

(22) PCT Filed: Apr. 19, 2023
(86) PCT No.: PCT/SE2023/050358

§ 371 Date: Oct. 15, 2025

(51) Int. Cl. H04W 72/1263; H04W 72/566

(52) U.S. Cl. CPC H04W 72/1263; H04W 72/566

(57) ABSTRACT

There is provided techniques for receiving SRs from UEs served by a network node. A method is performed by the network node. The method comprises assigning SR resources to the UEs. The SRs are scheduled in SR opportunities and frequency resources within an SR frequency range of a system bandwidth. The method comprises receiving the SRs using an NBR. The NBR has an operational bandwidth that covers less than the system bandwidth. Per given SR opportunity, only the SRs transmitted within the SR frequency range covered by the operational bandwidth of the NBR during the given SR opportunity are received. The method comprises decoding the received SRs.

### TECHNICAL FIELD

Embodiments presented herein relate to a method, a network node, a computer program, and a computer program product for receiving scheduling requests from user equipment served by the network node.

### BACKGROUND

In general terms, high band deployment is according to the third-generation partnership project (3GPP) referred to as deployment of wireless communication on frequencies higher than 6 GHz. To cope with coverage challenges at such high frequencies, more antenna elements are needed. In new radio (NR) type telecommunication systems, the notion of massive antenna arrays has been introduced to achieve both increased coverage and increased level of throughput.

These antenna arrays are sometimes referred to as Advanced Antenna Systems (AAS). According to 3GPP, an AAS is a defined collection of antenna elements, such as a panel of antenna elements, and is referred to as a transmission and reception point (TRP).

Analog beamforming can be used to reduce the cost of TRPs. Analog beamforming might also be used by the user equipment (UE) for such high band deployments.

Analog beamforming means that transmission and reception can only be performed in one beam at a time. This is since the spatial transmission or reception filter applies to all resource elements of an orthogonal frequency-division multiplexing (OFDM) symbol (per polarization). Analog beamforming can therefore be regarded as an example of time-domain beamforming, meaning that one beamform applies to all frequency resources being part of one transmission.

Hybrid beamforming, based on different sub-arrays of antenna elements connected to separate radio-frequency (RF) chains is another type of time-domain beamforming. Compared to strict digital beamforming, hybrid beamforming can be regarded as in the digital domain operating on an array of subarrays of antenna elements, as shown in FIG. 1. FIG. 1(a) is a front view of an AAS 240. The AAS 240 comprises a number of antenna panels, or antenna arrays, 242. Each antenna panel, or antenna array, 242 comprises one or more subarrays 244. In turn, each subarray is composed of one or more individual antenna elements 246. In the illustrative example of FIG. 1, the AAS 240 comprises 64 antenna elements per polarization in total (e.g., either 64 double-polarized antenna elements or 64 single-polarized antenna elements of each polarization), divided into 16 subarrays 244 in four panels, or antenna arrays, 242. FIG. 1(b) is a side view of the AAS 240. The AAS 240 is configured for analog beamforming, and two directions induced by analog beamforming for four of the subarrays are illustrated at reference numerals 270 and 280. As further illustrated, the AAS 240 is operatively connected, over an interface 260, to a digital beamforming module 250. FIG. 1 thus shows an example of hybrid beamforming, where each subarray is, over the interface 260, connected to a digital processing chain in the digital beamforming module 250. The subarrays of antenna elements are subject to analog beamforming and act as physical antenna elements, except that the beamforms of the subarrays, as given appropriate weights by means of analog beamforming, can each be pointing into different directions for a specific point in time. These sub-arrays might therefore be referred to as analog antenna subarrays.

Assuming one of the analog beams in FIG. 1, there is an option of digital beamforming. The case of no analog beamforming can be seen as there is simply only one direction available in FIG. 1. The digital beamforming may introduce a Grid of Beams (GoB), both in horizontal and vertical dimension.

Compared to full digital beamforming, hybrid beamforming reduces the need to transfer data between the frontend and the baseband. Another option to reduce the data transfer between baseband and frontend is to limit the number of (transmission) layers allowed at a specific time occasion. A yet further option is to use a digital receiver receiving data from all the analog antenna subarrays but on only a fraction of the resource elements in scope of the deployment. For the latter it could be that the receiver is configured to only receive in a limited bandwidth over some symbols (typically enough symbols to capture a full slot). Such a digital receiver is hereinafter referred to as a Narrowband Receiver (NBR). Whereas the use of such a narrowband receiver disregards from frequency-related information from the full bandwidth, it still allows the network node to spatially resolve the received signal from the grid of all the analog antenna subarrays (on a reduced bandwidth). This received signal is a superposition of signals received on each and every analog antenna subarray, assuming a certain direction induced by analog beamforming within the scope of the analog antenna subarrays.

Whatever version of beamforming is deployed, the UEs need to be able to inform the serving network whenever the UE needs to perform an uplink transmission of user data. The mechanism for this is the transmission of a Scheduling Request (SR), which is transmitted as part of uplink control signaling, as specified in 3GPP TS 38.211 “NR; Physical channels and modulation”, version 17.4.0. Typically, each UE would be assigned a specific resource for transmitting an SR. A UE would transmit an SR whenever the UE has uplink data to transmit but have not received any uplink grant with resources to transmit the uplink data on. Without this mechanism the UE would resort to random access whenever the UE needs uplink resources (and is not granted any).

In the case of purely analog beamforming, with one beam direction at a time, the network node would only be able to acquire (i.e., receive and decode) SRs from UEs within the coverage of that beam direction. This is an issue for UEs assigned resources (in which the SRs should be transmitted) in the same symbol since the network node does not have any prior information of whether any UE will actually transmit an SR or not. The network node therefore cannot predict towards which of the UEs a beam needs to be directed for reception of possible SRs. Accordingly, the network node, in terms of beamforming, needs to serve the UEs in a round robin fashion with latency that grows with load.

In the case of frequency-domain digital beamforming, the network node needs to combine all received data streams (one from each antenna element) after the point of the Fast Fourier Transform (FFT) as seen from uplink perspective. In this way, the network node can concurrently receive SRs from different directions and for different resources. However, in case of many antenna elements at the AAS (which is typical for high-band) it can be costly for the network node to manage all these data streams from the antenna elements all the way beyond the point of the Inverse FFT (IFFT) and the FFT.

In the case of time-domain digital beamforming, if only a few beams are allowed only SRs from a small number of beams could be served and the UEs may need to transmit their SRs repeatedly until served. If a large number of beams are used this would be subject to similar drawback as for the frequency-domain digital beamforming; it would be costly for the network node to manage all the data received in each beam. Adding an analog frontend (with subarrays of analog beamforming) would also present similar challenges.

In view of the above, there is still a need for improved techniques for how to handle SRs at the network node.

### SUMMARY

An object of embodiments herein is to address the above issues.

A particular object is to provide techniques that enable the network node to receive and decode SRs from its served UEs without suffering from the above-disclosed drawbacks.

According to a first aspect there is presented a method for receiving SRs from UEs served by a network node. The method is performed by the network node. The method comprises assigning SR resources to the UEs. The SRs are scheduled in SR opportunities and frequency resources within an SR frequency range of a system bandwidth. The method comprises receiving the SRs using an NBR. The NBR has an operational bandwidth that covers less than the system bandwidth. Per given SR opportunity, only the SRs transmitted within the SR frequency range covered by the operational bandwidth of the NBR during the given SR opportunity are received. The method comprises decoding the received SRs.

According to a second aspect there is presented a network node for receiving SRs from UEs served by the network node. The network node comprises processing circuitry. The processing circuitry is configured to cause the network node to assign SR resources to the UEs. The SRs are scheduled in SR opportunities and frequency resources within an SR frequency range of a system bandwidth. The processing circuitry is configured to cause the network node to receive the SRs using an NBR. The NBR has an operational bandwidth that covers less than the system bandwidth. Per given SR opportunity, only the SRs transmitted within the SR frequency range covered by the operational bandwidth of the NBR during the given SR opportunity are received. The processing circuitry is configured to cause the network node to decode the received SRs.

According to a third aspect there is presented a network node for receiving SRs from UEs served by the network node. The network node comprises an assign module configured to assign SR resources to the UEs. The SRs are scheduled in SR opportunities and frequency resources within an SR frequency range of a system bandwidth. The network node comprises a receive module configured to receive the SRs using an NBR. The NBR has an operational bandwidth that covers less than the system bandwidth. Per given SR opportunity, only the SRs transmitted within the SR frequency range covered by the operational bandwidth of the NBR during the given SR opportunity are received. The network node comprises a decode module configured to decode the received SRs.

According to a fourth aspect there is presented a computer program for receiving SRs from UEs served by a network node 200. The computer program comprises computer code which, when run on processing circuitry of the network node, causes the network node to perform actions. One action comprises the network node to to assign SR resources to the UEs. The SRs are scheduled in SR opportunities and frequency resources within an SR frequency range of a system bandwidth. One action comprises the network node to receive the SRs using an NBR. The NBR has an operational bandwidth that covers less than the system bandwidth. Per given SR opportunity, only the SRs transmitted within the SR frequency range covered by the operational bandwidth of the NBR during the given SR opportunity are received. One action comprises the network node to decode the received SRs.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient handling of SRs at the network node.

Advantageously, these aspects enable the network node to receive and decode SRs from its served UEs without the network node suffering from the above-disclosed drawbacks.

Advantageously, these aspects enable the network node to receive and decode SRs from high-priority UEs with low latency, whilst maintaining service also for non-high-priority UEs even in situations with high network load.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates an AAS according to an embodiment;

FIG. 2 is a schematic diagram illustrating a communications network according to embodiments;

FIG. 3 is a flowchart of methods according to embodiments;

FIG. 4 schematically illustrates an SR opportunity according to embodiments;

FIG. 5 schematically illustrates SR opportunities in which SRs are scheduled according to;

FIG. 6 is a schematic diagram showing functional units of a network node according to an embodiment;

FIG. 7 is a schematic diagram showing functional modules of a network node according to an embodiment; and

FIG. 8 shows one example of a computer program product comprising computer readable storage medium according to an embodiment.

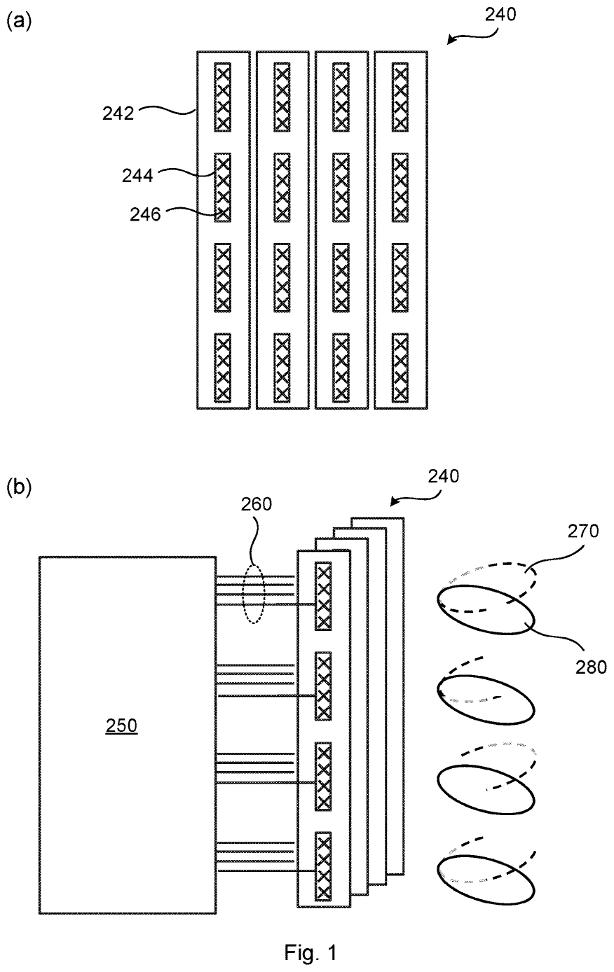

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

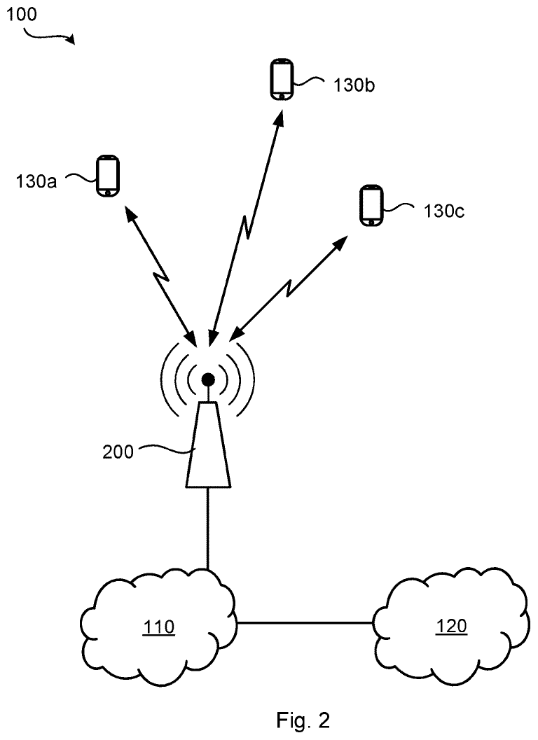

FIG. 2 is a schematic diagram illustrating a communications network 100 where embodiments presented herein can be applied. The communications network 100 could be a third generation (3G) telecommunications network, a fourth generation (4G) telecommunications network, or a fifth (5G) telecommunications network and support any 3GPP telecommunications standard, where applicable.

The communications network 100 comprises a network node 200 configured to provide network access to UEs 130a, 130b, 130c. The network node 200 is operatively connected to a core network 110. The core network 110 is in turn operatively connected to a service network 120, such as the Internet. The UEs 130a, 130b, 130c are thereby enabled to, via the network node 200, access services of, and exchange data with, the service network 120. In general terms, the UEs 130a, 130b, 130c can be categorized as being high-priority UEs or not high-priority UEs. In this respect, UEs 130a, 130b are for illustrative purposes assumed to be high-priority UEs whereas UE 130c is assumed to not be a high-priority UE. A high-priority UE 130a, 130b could be a UE 130a that by the network node 200 is associated with a prioritized service and/or a UE 130b that is a cell-edge UE. The network node 200 could, for example, identify cell-edge UEs (or other type of coverage-limited UEs) based on measurement reports. The measurement report could be a channel state information (CSI) report for beam management or simply include the received signal to interference plus noise ratio (SINR) of a downlink transmission.

Examples of network nodes 200 are radio access network nodes, radio base stations, base transceiver stations, Node Bs, evolved Node Bs, gNBs, TRPs, access points, access nodes, and integrated access and backhaul nodes. Examples of UEs 130a, 130b, 130c are wireless devices, mobile stations, mobile phones, handsets, wireless local loop phones, smartphones, laptop computers, tablet computers, network equipped sensors, network equipped vehicles, and so-called Internet of Things devices.

As noted above, there is still a need for improved techniques for how to handle SRs, as transmitted by the UEs 130a, 130b, 130c, at the network node 200.

The embodiments disclosed herein therefore relate to techniques for receiving SRs from UEs 130a, 130b, 130c served by the network node 200. In order to obtain such techniques there is provided a network node 200, a method performed by the network node 200, a computer program product comprising code, for example in the form of a computer program, that when run on a network node 200, causes the network node 200 to perform the method.

Techniques where the network node 200 uses an NBR for reception, per SR opportunity, only in limited bandwidth would reduce the amount of data managed by the network node 200. An SR opportunity for a UE means that reception on the SR resource of the UE is enabled at the network node 200. In case beamforming is used, this means that the network node 220 has a beam that is covering the location of the UE when the SR is transmitted from the UE. The number of SR resources that would fit the limited bandwidth is likewise limited. This could be an issue since a UE needs to be assigned SRs that are scheduled in SR opportunities and frequency resources to avoid random access whenever the UE has data in its buffer and has not been granted (sufficient) uplink resources for uplink transmission of the data. Moreover, if there is an analog frontend configured for (analog) beamforming, the reception in the limited bandwidth of the NBR also needs to consider the analog beam directions induced by the analog beamforming. Whether a UE is actually transmitting an assigned SR in a given SR opportunity is not relevant; the SR opportunity has been offered anyway.

One remaining issue can therefore be how to prioritize some UEs 130a, 130b such that they would be offered SR opportunities more often compared to non-prioritized users. This issue is addressed by at least some of the embodiments as disclosed next.

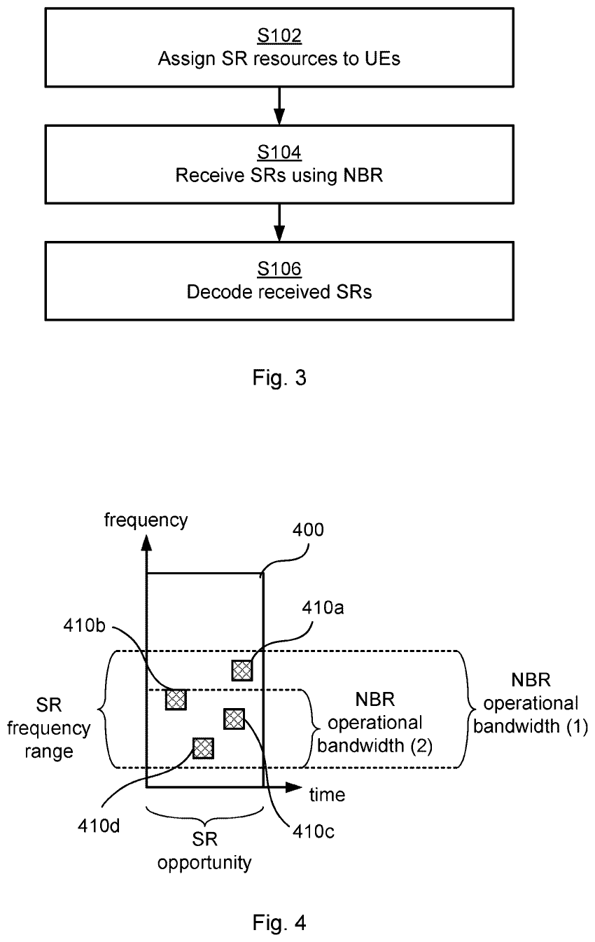

FIG. 3 is a flowchart illustrating embodiments of methods for receiving SRs from UEs 130a, 130b, 130c served by the network node 200. The methods are performed by the network node 200. The methods are advantageously provided as computer programs 820.
S102: The network node 200 assigns SR resources to the UEs 130a, 130b, 130c. The SR resources are scheduled in SR opportunities and frequency resources within an SR frequency range of a system bandwidth.
S104: The network node 200 receives, using an NBR, SRs as transmitted in the assigned SR resources. The NBR has an operational bandwidth that covers less than the system bandwidth. Per given SR opportunity, only the SRs transmitted within the SR frequency range covered by the operational bandwidth of the NBR during the given SR opportunity are received.
S106: The network node 200 decodes the received SRs.

Hence, just SRs transmitted within the SR frequency range covered by the operational bandwidth of the NBR during the given SR opportunity will be received and then decoded.

Embodiments relating to further details of receiving SRs from UEs 130a, 130b, 130c served by the network node 200 as performed by the network node 200 will now be disclosed.

As noted above, the NBR has an operational bandwidth that covers less than the system bandwidth. There can be different properties of this operational bandwidth.

In some embodiments, the operational bandwidth of the NBR covers less than the SR frequency range. In other embodiments, the operational bandwidth of the NBR at least covers the whole SR frequency range.

In case the operational bandwidth of the NBR covers less than the SR frequency range, the need for SR resources exceeds the operational bandwidth of the NBR. Different aspects relating thereto will be disclosed next.

In some embodiments, the frequency location of the operational bandwidth of the NBR is, during reception of the SR requests, shifted between the SR opportunities. In this way the NBR selectively covers at least two different parts of the SR frequency range during two consecutive SR opportunities. Hence, the network node 200 is thereby enabled to, over time, cycle the NBR reception over the full SR frequency range such that each resource in which an SR might be transmitted is received. Thereby, even at the lowest possible periodicity based on the used time-division duplex (TDD) pattern (as given by the parameter periodicityAndOffset), the NBR can offer further differentiation at high network loads.

In some embodiments, the at least two different parts are partly, but not fully, overlapping. In this way the network node 200 can serve frequency regions containing resources in which an SR might be transmitted for high-priority users more often. In this respect, high-priority users might be assigned SR resources that are scheduled in frequency resources in some frequency region that is always served by the NBR. That is, in some embodiments at least some of the UEs 130a, 130b, 130c are high-priority UEs 130a, 130b, and the high-priority UEs 130a, 130b are assigned SR resources that are scheduled in frequency resources in the overlapping of the at least two parts of the SR frequency range. Further in this respect, in some embodiments, the SR resources that are scheduled in frequency resources in the overlapping of the at least two parts of the SR frequency range are assigned to the high-priority UEs 130a, 130b. As disclosed above, the high-priority UEs 130a, 130b might by the network node 200 be associated with a prioritized service and/or be cell-edge UEs.

In some aspects, the offering of SR opportunities are based on scheduling weights per user.

In particular, in some embodiments, each of the UEs 130a, 130b, 130c is associated with a scheduling weight. The scheduling weights are then accumulated per each part of the SR frequency range depending on in which frequency resources the SR resources that are assigned to the UEs 130a, 130b, 130c are scheduled. The order in which the operational bandwidth of the NBR is shifted can then be defined by the accumulated scheduling weights per each part of the SR frequency range. In some aspects, the network node 200, in addition to the NBR grid of beams, is configured for analog beamforming, and the network node 200, during reception of the SRs, performs a beam sweep in directions, or beams, induced by the analog beamforming. The grid of beams induced by digital beamforming, may for example be beams in the azimuth direction whereas the directions induced by analog beamforming may relate to vertical directions. Hence, the network node 200 might not only, via the NBR, cycle over some frequency regions, but also cycle over some beams induced by analog beamforming. In this respect, beams might be pointed towards the high-priority UEs 130a, 130b more often than towards the remaining UEs 130b so that the NBR performs reception more often of the SR opportunities in which the SRs assigned to the high-priority UEs 130a, 130b are scheduled.

As for the order in which the operational bandwidth of the NBR is shifted from one SR opportunity to the next can be based on scheduling weights, scheduling weights can also be used to determine the order in which the beams 270, 280 are swept during the beam sweep. That is, in some embodiments, each of the UEs 130a, 130b, 130c is associated with a scheduling weight, where the scheduling weights are accumulated per each beam 270, 280 in which the UEs 130a, 130b, 130c are served, and the order in which the beams 270, 280 are swept during the beam sweep is defined by the accumulated scheduling weights per each of the beams 270, 280.

In some aspects, whenever an SR opportunity for a given UE is not decoded, the scheduling weight for this given UE is incremented by one unit. Likewise, when the SR opportunity for a given UE indeed is decoded the scheduling weight for this given UE is reset. That is, in some embodiments, for each SR opportunity, the scheduling weight is increased for any UEs 130a, 130b, 130c which SRs are not decoded, and the scheduling weight is reset for any UEs 130a, 130b, 130c which SRs are decoded. This applies regardless if the scheduling weights are used to determine the order in which the operational bandwidth of the NBR is shifted from one SR opportunity to the next or if the scheduling weights are used to determine the order in which the beams 270, 280 are swept during the beam sweep. For example, when the SR frequency range is larger than the operational bandwidth of the NBR range and analog beamforming is used, the operational bandwidth of the NBR might be shifted over the frequency range whilst analog beamforming is performed. In this case the scheduling weights could determine the combined order of frequency range and beam to use for reception of the SRs. A simple way to define the order is to, for each SR opportunity, select the combination of bandwidth and beam that contains the UE 130a, 130b, 130c with the highest scheduling weight.

Even though the network node 200 assigns the SR resources to the UEs 130a, 130b, 130c, as in S102, where the SRs are scheduled in SR opportunities and frequency resources within the SR frequency range, there could be different ways for the UEs 130a, 130b, 130c to transmit the SRs. In some examples, the SRs are received as appended to hybrid automatic repeat request (HARQ) feedback from the UEs 130a, 130b, 130c.

In FIG. 4 is illustrated an example of a scheduling opportunity 400 in which four SR resources 410a, 410b, 410c, 410d have been assigned. It is here noted that the illustration is simplified for illustrational purposes and that the scheduling opportunity might comprise more than four SR resources. In FIG. 4 is also indicated the SR frequency range in which the SRs are scheduled as well as the operational bandwidth of the NBR according to two examples. In the first example (denoted NBR operational bandwidth (1)), the operational bandwidth of the NBR at least covers the whole SR frequency range. In the second example (denoted NBR operational bandwidth (2)), the operational bandwidth of the NBR covers less than the SR frequency range. However, the SR frequency range is less than double the operational bandwidth of the NBR for the second case. That is, in FIG. 4, “NBR operational bandwidth (2)” times two is larger than “SR frequency range”.

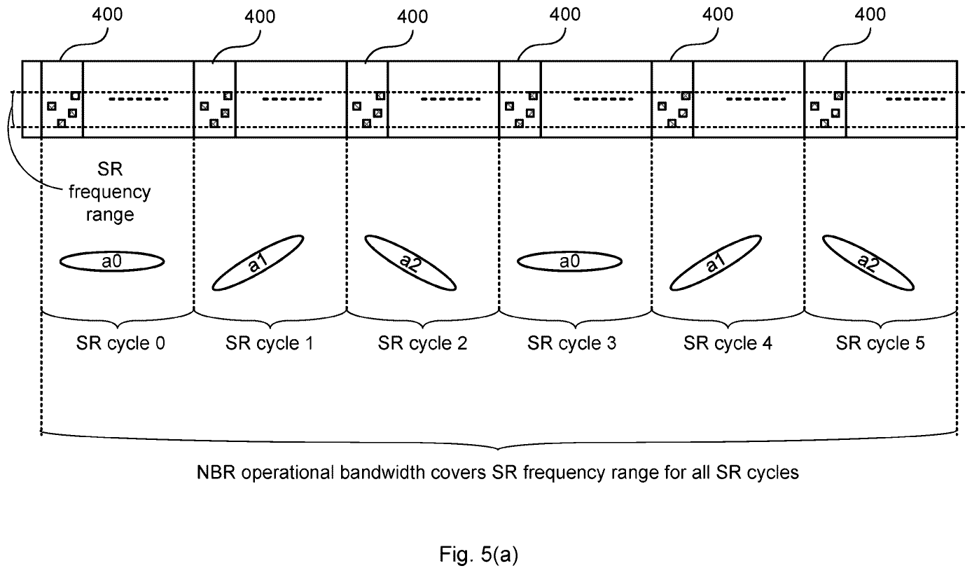

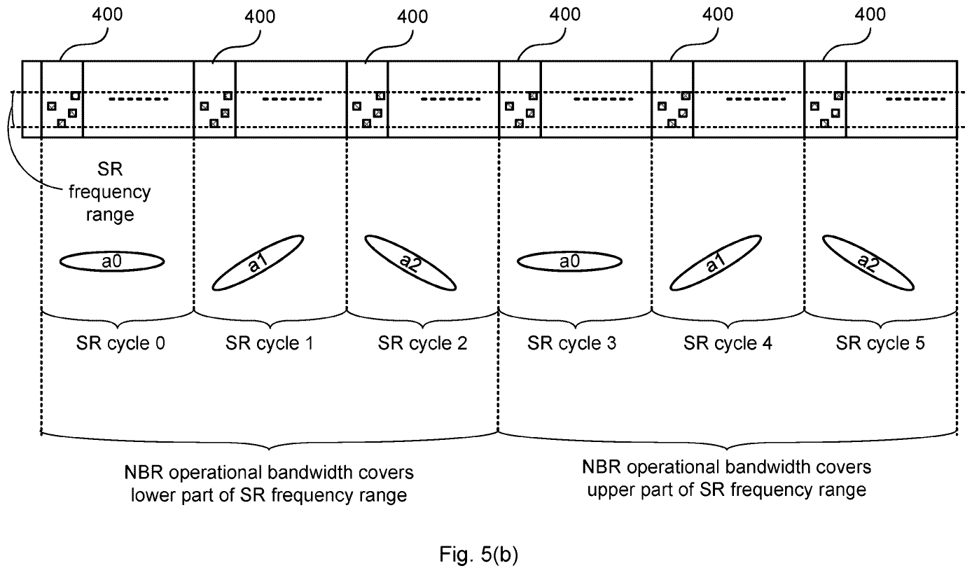

An example where the operational bandwidth of the NBR at least covers the whole SR frequency range will be disclosed next with reference to FIG. 5(a). In FIG. 5(a) is schematically illustrated six SR opportunities 400 in which SR resources have been assigned, with one SR opportunity per SR cycle. In the example there are three beams a0, a1, and a2, induced by analog beamforming, and a beam sweep is made over the three beams a0, a1, and a2, where one of these beams thus is used for reception of the SRs per each SR opportunity. Also the coverage of the operational bandwidth of the NBR with respect to the SR frequency range is shown. If the frequency range containing SR resources is not larger than the bandwidth of the NBR there is no need for differentiating, with respect to frequency covering by the NBR, the reception of SRs. This is the case in FIG. 5(a) where the SR frequency range fits into the operational bandwidth of the NBR. Hence, the frequency region as covered by the operational bandwidth of the NBR can stay the same for all SR opportunities. Since each SR opportunity contains a certain number of physical resource blocks (PRBs) and each such PRB is configured with a certain number of cyclic shifts, there will only be support for as many resources for SRs as there are pairs of PRBs and cyclic shifts. For example, if there are M PRBs used for SRs and each PRB is configured with N cyclic shifts, then there are M times N unique resources in which an SR can be scheduled.

An example where the operational bandwidth of the NBR covers less than the SR frequency range will be disclosed next with reference to FIG. 5(b). In FIG. 5(b) is schematically illustrated six SR opportunities 400 in which SRs are scheduled, with one SR opportunity per SR cycle. A beam sweep is made in beams a0, a1, and a2, where one of these beams thus is used for reception of the SRs per each SR opportunity. Also the coverage of the operational bandwidth of the NBR with respect to the SR frequency range is indicated. If the need for SR resources causes the SR frequency range to exceed the operational bandwidth of the NBR, the frequency range of the NBR can be cycled over the range of the SR resources (to avoid allocating more symbols for SR). Hence, in contrast to the example in FIG. 5(a) the frequency region as covered by the operational bandwidth of the NBR can no longer stay the same for all SR opportunities. In FIG. 5(b) the location of the operational bandwidth of the NBR is therefore shifted between first covering the lower part of the SR frequency range and then covering the upper part of the SR frequency range, where the middle part of the SR frequency range always is within the operational bandwidth of the NBR. This is possible as long as the SR frequency range is less than double the operational bandwidth of the NBR, as in FIG. 4. SR resources as assigned to high-priority UEs 130a, 130b can then be scheduled in the overlapping frequency region (i.e., the middle part of the SR frequency range). The high-priority UEs 130a, 130b would then be given half the latency compared to the (normal-priority) UEs 130c assigned SR resources scheduled outside the overlapping frequency region (but still within the SR frequency range).

It is noted that although the beams a0, a1, a2 in FIG. 5(b) are swept in the order a0, a1, a2, a0, a1, a2 over the six SR opportunities and that the operational bandwidth of the NBR for the first three SR opportunities covers lower part of the SR frequency range and in the last three SR opportunities covers the upper part of the SR frequency range, this is just an example and other combinations are likewise possible. For example, the beams a0, a1, a2 could be swept in the order a0, a0, a1, a1, a2, a2, . . . whilst the operational bandwidth of the NBR is shifted according to the pattern L, U, L, U, L, U, . . . (where “L” denotes that the operational bandwidth of the NBR covers lower part of the SR frequency range, and “U” denotes that the operational bandwidth of the NBR covers upper part of the SR frequency range). For example, the beams a0, a1, a2 could be swept in the order a0, a1, a0, a2, a0, a1, a0, a2, . . . whilst the operational bandwidth of the NBR is shifted according to the pattern L, L, U, L, L, U, U, U, . . . , and so on. Moreover, if the network node 200 knows there are no UEs 130a, 130b, 130c in one direction, the network node 200 can exclude that beam from the sweep.

As a comparison, a network node 200 using pure analog beamforming (without using an NBR) that is to receive SRs from N high-priority UEs 130a, 130b would be subject to a latency of N times the SR periodicity. This is since for each SR opportunity one narrow beam is directed towards one specific high-priority UE 130a, 130b. At the same time the SRs from no other (normal-priority) UE 130c can be received, meaning that for this strict priority approach there would be no service for the other UEs 130c. A network node 200 using hybrid beamforming system (without using an NBR) that is to receive SRs from N high-priority UEs 130a, 130b distributed in M different directions induced by analog beamforming would be subject to a latency of M times the SR periodicity. This is since at each SR opportunity and direction induced by analog beamforming, the SRs from many high-priority UEs 130a, 130b can concurrently be received by the NBR. For this case the SRs from other (normal-priority) UEs 130c would also be received but not as often as the SRs from high-priority UEs 130a, 130b.

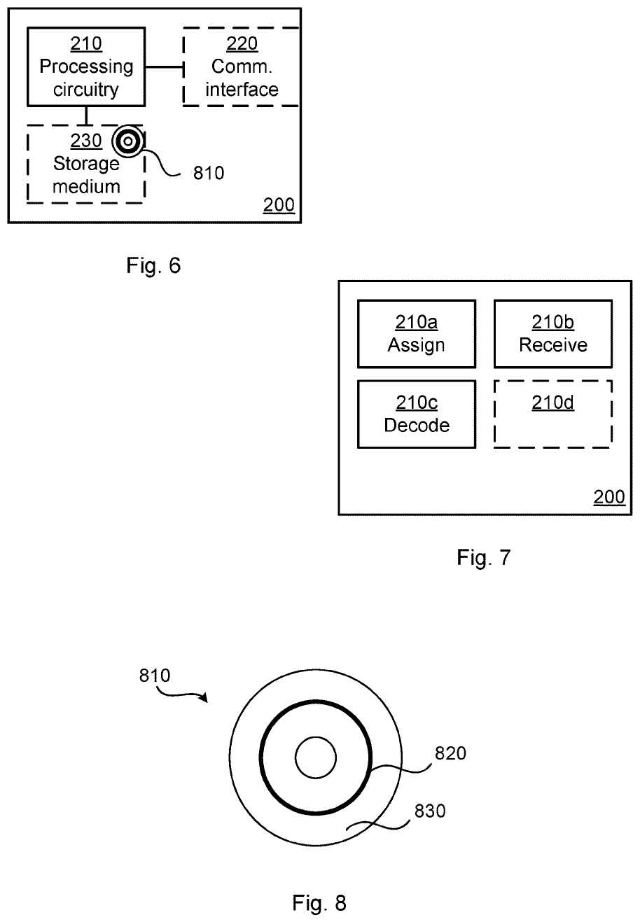

FIG. 6 schematically illustrates, in terms of a number of functional units, the components of a network node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node 200 to perform a set of operations, or steps, as disclosed above. For example, the storage medium 230 may store the set of operations, and the processing circuitry 210 may be configured to retrieve the set of operations from the storage medium 230 to cause the network node 200 to perform the set of operations. The set of operations may be provided as a set of executable instructions.

Thus, the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node 200 may further comprise a communications (comm.) interface 220 at least configured for communications other entities, functions, nodes, and devices, as illustrated in FIG. 2. As such the communications interface 220 may comprise one or more transmitters and receivers, comprising analogue and digital components. For example, the communications interface 220 might comprise, or implement, the NBR. The processing circuitry 210 controls the general operation of the network node 200 e.g. by sending data and control signals to the communications interface 220 and the storage medium 230, by receiving data and reports from the communications interface 220, and by retrieving data and instructions from the storage medium 230. Other components, as well as the related functionality, of the network node 200 are omitted in order not to obscure the concepts presented herein.

FIG. 7 schematically illustrates, in terms of a number of functional modules, the components of a network node 200 according to an embodiment. The network node 200 of FIG. 7 comprises a number of functional modules; an assign module 210a configured to perform step S102, a receive module 210b configured to perform step S104, and a decode module 210c configured to perform step S106. For example, the receive module 210b might comprise, or implement, the NBR. The network node 200 of FIG. 7 may further comprise a number of optional functional modules, as represented by functional module 210d. In general terms, each functional module 210a:210d may in one embodiment be implemented only in hardware and in another embodiment with the help of software, i.e., the latter embodiment having computer program instructions stored on the storage medium 230 which when run on the processing circuitry makes the network node 200 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein. The network node 200 may be provided as a standalone device or as a part of at least one further device. For example, the network node 200 may be provided in a node of the radio access network or in a node of the core network. Alternatively, functionality of the network node 200 may be distributed between at least two devices, or nodes.

These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the network node 200 may be executed in a first device, and a second portion of the of the instructions performed by the network node 200 may be executed in a second device; the herein disclosed embodiments are not limited to any particular number of devices on which the instructions performed by the network node 200 may be executed. Hence, the methods according to the herein disclosed embodiments are suitable to be performed by a network node 200 residing in a cloud computational environment. Therefore, although a single processing circuitry 210 is illustrated in FIG. 6 the processing circuitry 210 may be distributed among a plurality of devices, or nodes. The same applies to the functional modules 210a:210d of FIG. 7 and the computer program 820 of FIG. 8.

Some (radio) access network architectures define network nodes 200 (or gNBs) comprising multiple component parts or nodes: a central unit (CU), one or more distributed units (DUs), and one or more radio units (RUs). The protocol layer stack of the network node is divided between the CU, the DUs and the RUs, with one or more lower layers of the stack implemented in the RUs, and one or more higher layers of the stack implemented in the CU and/or DUs. The CU is coupled to the DUs via a fronthaul higher layer split (HLS) network; the CU/DUs are connected to the RUs via a fronthaul lower-layer split (LLS) network. The DU may be combined with the CU in some embodiments, where a combined DU/CU may be referred to as a CU or simply a baseband unit. A communication link for communication of user data messages or packets between the RU and the baseband unit, CU, or DU is referred to as a fronthaul network or interface. Messages or packets may be transmitted from the network node 200 in the downlink (i.e., from the CU to the RU) or received by the network node 200 in the uplink (i.e., from the RU to the CU).

FIG. 8 shows one example of a computer program product 810 comprising computer readable storage medium 830. On this computer readable storage medium 830, a computer program 820 can be stored, which computer program 820 can cause the processing circuitry 210 and thereto operatively coupled entities and devices, such as the communications interface 220 and the storage medium 230, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for receiving scheduling requests, SRs, from user equipment, UEs, served by a network node wherein the method is performed by the network node, and wherein the method comprises:
assigning SR resources to the UEs wherein the SR resources are scheduled in SR opportunities and frequency resources within an SR frequency range of a system bandwidth;
receiving the SRs using a narrowband receiver, NBR, wherein the NBR has an operational bandwidth that covers less than the system bandwidth, and wherein, per given SR opportunity, only the SRs transmitted within the SR frequency range covered by the operational bandwidth of the NBR during the given SR opportunity are received; and
decoding the received SRs.

2. The method according to claim 1, wherein the operational bandwidth of the NBR covers less than the SR frequency range.

3. The method according to claim 2, wherein the operational bandwidth of the NBR, during reception of the SR requests, is shifted between the SR opportunities for the NBR to selectively cover at least two different parts of the SR frequency range during two consecutive SR opportunities.

4. The method according to claim 3, wherein, when the at least two different parts are partly, but not fully, overlapping.

5. The method according to claim 4, wherein at least some of the UEs are high-priority UEs, and wherein the high-priority UEs are assigned SR resources that are scheduled in frequency resources in the overlapping of the at least two parts of the SR frequency range.

6. The method according to claim 4, wherein at least some of the UEs are high-priority UEs, and wherein the SR resources that are scheduled in frequency resources in the overlapping of the at least two parts of the SR frequency range are assigned to the high-priority UEs

7. The method according to claim 4, wherein the high-priority UEs are by the network node associated with a prioritized service and/or are cell-edge UEs.

8. The method according to claim 3, wherein each of the UEs is associated with a scheduling weight, wherein the scheduling weights are accumulated per each part of the SR frequency range depending on in which frequency resources the SR resources that are assigned to the UEs are scheduled, and wherein an order in which the operational bandwidth of the NBR is shifted is defined by the accumulated scheduling weights per each part of the SR frequency range.

9. The method according to claim 8, wherein for each SR opportunity, the scheduling weight is increased for any UEs which SRs are not decoded, and the scheduling weight is reset for any UEs which SRs are decoded.

10. The method according to claim 1, wherein the operational bandwidth of the NBR at least covers the whole SR frequency range.

11. The method according to claim 1, wherein the SRs are received as appended to hybrid automatic repeat request, HARQ, feedback from the UEs.

12. The method according to claim 1, wherein the network node is configured for analog beamforming, and wherein the network node during reception of the SRs, performs a beam sweep in directions induced by the analog beamforming.

13. The method according to claim 12, wherein each of the UEs is associated with a scheduling weight, wherein the scheduling weights are accumulated per each beam in which the UEs are served, and wherein an order in which the beams are swept during the beam sweep is defined by the accumulated scheduling weights per each of the beams.

14. A network node for receiving scheduling requests, SRs, from user equipment, UEs, served by the network node, the network node comprising processing circuitry, the processing circuitry being configured to cause the network node to:
assign SR resources to the UEs wherein the SRs are scheduled in SR opportunities and frequency resources within an SR frequency range of a system bandwidth;
receive the SRs using a narrowband receiver, NBR, wherein the NBR has an operational bandwidth that covers less than the system bandwidth, and wherein, per given SR opportunity, only the SRs transmitted within the SR frequency range covered by the operational bandwidth of the NBR during the given SR opportunity are received; and
decode the received SRs.

15. (canceled)

16. The network node according to claim 14, wherein the operational bandwidth of the NBR covers less than the SR frequency range.

17. (canceled)

18. A computer program product comprising a computer program for receiving scheduling requests, SRs, from user equipment, UEs, served by a network node, and a computer readable storage medium on which the computer program is stored, the computer program comprising computer code which, when run on processing circuitry of the network node, causes the network node to:
assign SR resources to the UEs, wherein the SRs are scheduled in SR opportunities and frequency resources within an SR frequency range of a system bandwidth;
receive the SRs using a narrowband receiver, NBR, wherein the NBR has an operational bandwidth that covers less than the system bandwidth, and wherein, per given SR opportunity, only the SRs transmitted within the SR frequency range covered by the operational bandwidth of the NBR during the given SR opportunity are received; and
decode the received SRs.
